(19) United States
(12) Patent Application Publication
(10) Pub. No.: US 2025/0135395 A1
(43) Pub. Date: May 1, 2025

(54) CARBON DIOXIDE RECOVERY SYSTEM

(71) Applicant: DENSO CORPORATION, Kariya-city (JP)

(72) Inventors: Yuki FUJITA, Kariya-city (JP); Eiichi HIROSE, Kariya-city (JP)

(21) Appl. No.: 18/921,047

(22) Filed: Oct. 21, 2024

(30) Foreign Application Priority Data
Oct. 31, 2023 (JP) 2023-186686

(51) Int. Cl. B01D 53/32; B01D 53/62

(52) U.S. Cl. CPC B01D 53/326; B01D 53/62; B01D 2256/12; B01D 2257/504

(57) ABSTRACT

A carbon dioxide recovery system includes an electrochemical cell that includes a working electrode, a counter electrode, and an insulating layer. The electrochemical cell is configured to repeat an adsorption mode and a desorption mode. In the adsorption mode, a first voltage is applied between the working electrode and the counter electrode to supply electrons to the working electrode and cause the working electrode to adsorb carbon dioxide in a gas to be treated. In the desorption mode, a second voltage different from the first voltage is applied between the working electrode and the counter electrode to emit electrons from the working electrode and desorb the carbon dioxide from the working electrode. At least one of the adsorption mode and the desorption mode has a pause period during which application of a predetermined voltage between the working electrode and the counter electrode is temporarily suspended.

### CROSS REFERENCE TO RELATED APPLICATION

The present application claims the benefit of priority from Japanese Patent Application No. 2023-186686 filed on Oct. 31, 2023. The entire disclosure of the above application is incorporated herein by reference.

### TECHNICAL FIELD

The present disclosure relates to a carbon dioxide recovery system.

### BACKGROUND

There has been known a carbon dioxide recovery system including an electrochemical cell equipped with a working electrode and a counter electrode. In the carbon dioxide recovery system, a first voltage is applied between the working electrode and the counter electrode to adsorb carbon dioxide onto the working electrode, and a second voltage is applied between the working electrode and the counter electrode to desorb carbon dioxide from the working electrode.

### SUMMARY

A carbon dioxide recovery system according to an aspect of the present disclosure includes an electrochemical cell. The electrochemical cell includes a working electrode configured to come in contact with a gas to be treated that contains carbon dioxide, a counter electrode, and an insulating layer disposed between the working electrode and the counter electrode. The electrochemical cell is configured to repeat an adsorption mode and a desorption mode. The adsorption mode is a mode in which a first voltage is applied between the working electrode and the counter electrode to supply electrons to the working electrode and cause the working electrode to adsorb the carbon dioxide in the gas to be treated. The desorption mode is a mode in which a second voltage different from the first voltage is applied between the working electrode and the counter electrode to emit electrons from the working electrode and desorb the carbon dioxide from the working electrode. At least one of the adsorption mode and the desorption mode has a pause period during which application of a predetermined voltage between the working electrode and the counter electrode is temporarily suspended. The predetermined voltage is the first voltage in the adsorption mode, and is the second voltage in the desorption mode.

### BRIEF DESCRIPTION OF DRAWINGS

Objects, features and advantages of the present disclosure will become apparent from the following detailed description made with reference to the accompanying drawings. In the drawings:

FIG. 1 is a block diagram of a carbon dioxide recovery system according to a first embodiment;

FIG. 2 is a perspective view of a carbon dioxide (CO₂) recovery device according to the first embodiment;

FIG. 3 is a cross-sectional view of an electrochemical cell according to the first embodiment;

FIG. 4A is a diagram illustrating an adsorption mode of the CO₂ recovery device according to the first embodiment;

FIG. 4B is a diagram illustrating a desorption mode of the CO₂ recovery device according to the first embodiment;

FIG. 5 is a schematic diagram of an electrochemical cell in the adsorption mode according to the first embodiment;

FIG. 6 is a schematic diagram of an electrochemical cell in the desorption mode according to the first embodiment;

FIG. 7 is a schematic circuit diagram of the CO₂ recovery device according to the first embodiment;

FIG. 8 is a diagram illustrating a voltage application period and a rest period according to the first embodiment;

FIG. 9 is a diagram showing an example of fluctuations in inter-electrode voltage and current value of the electrochemical cell according to the first embodiment;

FIG. 10 is an enlarged view of a portion of FIG. 9, showing a graph illustrating the fluctuation in the inter-electrode voltage in the adsorption mode;

FIG. 11 is an enlarged view of a portion of FIG. 9, showing a graph illustrating the fluctuation in the current value in the adsorption mode;

FIG. 12 is a graph showing measurement results of carbon dioxide recovery capacities in a comparative example and the first embodiment;

FIG. 13 is a schematic circuit diagram of a CO₂ recovery device according to a second embodiment;

FIG. 14 is a schematic circuit diagram of a CO₂ recovery device according to a third embodiment;

FIG. 15 is a schematic diagram of a portion in the vicinity of a working electrode of an electrochemical cell in an adsorption mode according to a fifth embodiment; and

FIG. 16 is a schematic diagram of a portion in the vicinity of the working electrode of the electrochemical cell in a desorption mode according to the fifth embodiment.

### DETAILED DESCRIPTION

Conventional carbon dioxide recovery systems have room for improvement in terms of processing capacity. That is, it is desired to improve a carbon dioxide recovery capacity by further improving the efficiency of adsorption of carbon dioxide to a working electrode or the efficiency of desorption of carbon dioxide from the working electrode.

A carbon dioxide recovery system according to an aspect of the present disclosure includes an electrochemical cell. The electrochemical cell includes a working electrode configured to come in contact with a gas to be treated that contains carbon dioxide, a counter electrode, and an insulating layer disposed between the working electrode and the counter electrode. The electrochemical cell is configured to repeat an adsorption mode and a desorption mode. The adsorption mode is a mode in which a first voltage is applied between the working electrode and the counter electrode to supply electrons to the working electrode and cause the working electrode to adsorb the carbon dioxide in the gas to be treated. The desorption mode is a mode in which a second voltage different from the first voltage is applied between the working electrode and the counter electrode to emit electrons from the working electrode and desorb the carbon dioxide from the working electrode. At least one of the adsorption mode and the desorption mode has a pause period during which application of a predetermined voltage between the working electrode and the counter electrode is temporarily suspended. The predetermined voltage is the first voltage in the adsorption mode, and is the second voltage in the desorption mode.

In the carbon dioxide recovery system of the above aspect, at least one of the adsorption mode and the desorption mode has the pause period. Accordingly, it is possible to improve at least one of the efficiency of adsorption of carbon dioxide in the adsorption mode and the efficiency of desorption of carbon dioxide in the desorption mode. As a result, the carbon dioxide recovery capacity can be improved.

As described above, according to the above aspect, it is possible to provide a carbon dioxide recovery system capable of improving the carbon dioxide recovery capacity.

### First Embodiment

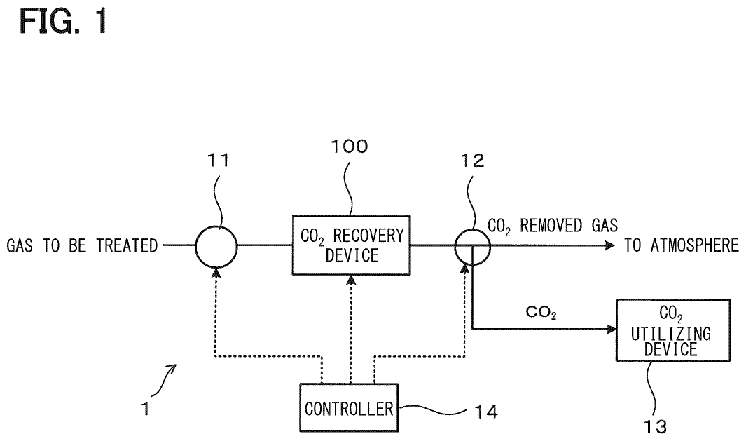

Carbon dioxide recovery systems according to embodiments of the present disclosure will be described with reference to FIGS. 1 to 11. A carbon dioxide recovery system 1 according to a first embodiment is a system that separates carbon dioxide (CO₂) from a gas to be treated that contains carbon dioxide by electrochemical reactions.

As shown in FIGS. 1 to 3, the carbon dioxide recovery system 1 includes an electrochemical cell 101. The electrochemical cell 101 includes a working electrode 102 that comes into contact with the gas to be treated, and a counter electrode 103 that is disposed opposite the working electrode 102 with an insulating layer 104 interposed therebetween.

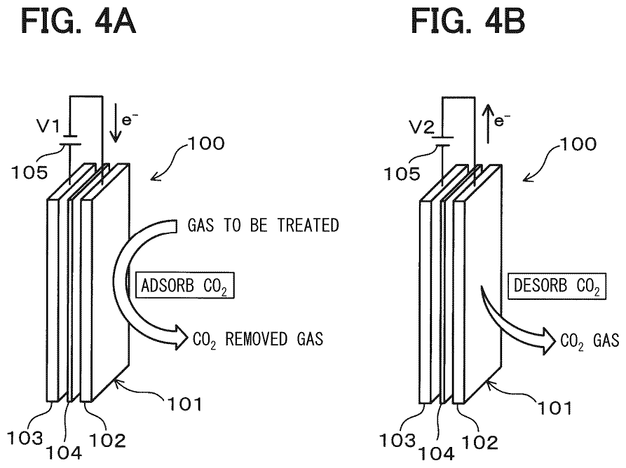

The carbon dioxide recovery system 1 is configured to repeat an adsorption mode shown in FIG. 4A and a desorption mode shown in FIG. 4B. The adsorption mode is a mode in which a first voltage V1 is applied between the working electrode 102 and the counter electrode 103 to supply electrons to the working electrode 102, thereby causing the working electrode 102 to adsorb the carbon dioxide in the gas to be treated. The desorption mode is a mode in which a second voltage V2 different from the first voltage V1 is applied between the working electrode 102 and the counter electrode 103 to emit electrons from the working electrode 102 and desorb the carbon dioxide from the working electrode 102.

In at least one of the adsorption mode and the desorption mode, the carbon dioxide recovery system 1 has a pause period B during which application of a predetermined voltage between the working electrode 102 and the counter electrode 103 is temporarily suspended (see FIG. 8 described later). Here, application of a predetermined voltage means application of the first voltage V1 in the adsorption mode, and means application of the second voltage V2 in the desorption mode. Unless otherwise specified, each of the first voltage and the second voltage is expressed as a potential of the working electrode 102 based on a potential of the counter electrode 103.

At least one of the adsorption mode and the desorption mode may have a plurality of pause periods B. In the present embodiment, the adsorption mode has a plurality of pause period B, and the desorption mode does not include a pause period.

As shown in FIG. 1, the carbon dioxide recovery system 1 includes a compressor 11, a CO₂ recovery device 100, a flow path switching valve 12, a CO₂ utilizing device 13, and a controller 14.

The compressor 11 pumps the gas to be treated to the CO₂ recovery device 100. The gas to be treated is a mixed gas containing CO₂ and a gas other than CO₂. In the present embodiment, the gas to be treated also contains oxygen (O₂). The gas to be treated may be, for example, the atmosphere or the exhaust gas of an internal combustion engine.

The CO₂ recovery device 100 is a device that separates and recovers CO₂ from the gas to be treated. The CO₂ recovery device 100 discharges a CO₂ removed gas after CO₂ has been recovered and removed from the gas to be treated, or discharges the CO₂ recovered from the gas to be treated. The configuration of the CO₂ recovery device 100 will be described in detail later.

The flow path switching valve 12 is a three-way valve that switches a passage of exhaust gas from the CO₂ recovery device 100. When the CO₂ removed gas is discharged from the CO₂ recovery device 100, the flow path switching valve 12 connects the flow path of the exhaust gas to the atmosphere. When CO₂ is discharged from the CO₂ recovery device 100, the flow path switching valve 12 connects the flow path of the exhaust gas to the CO₂ utilizing device 13.

The CO₂ utilizing device 13 is a device that utilizes CO₂. The CO₂ utilizing device 13 may be a storage tank for storing CO₂ or a conversion device for converting CO₂ into fuel. As the conversion device, a device that converts CO₂ into a hydrocarbon fuel such as methane can be used. The hydrocarbon fuel may be gaseous fuel at normal temperature and pressure, or may be liquid fuel at normal temperature and pressure.

The controller 14 includes a well-known microcontroller including a central processing device (CPU), a read only memory (ROM), a random access memory (RAM) and the like, and peripheral circuits thereof. The controller 14 performs various calculations and processes based on control programs stored in the ROM, and controls actuations of various devices connected to an output side of the controller 14. The controller 14 of the present embodiment performs an operation control of the compressor 11, an operation control of the CO₂ recovery device 100, a passage switching control of the flow path switching valve 12 and the like.

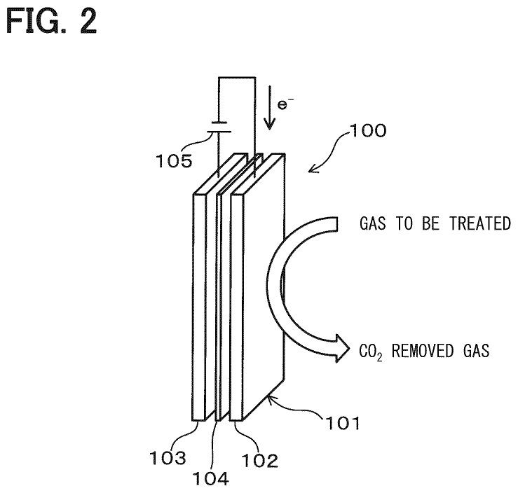

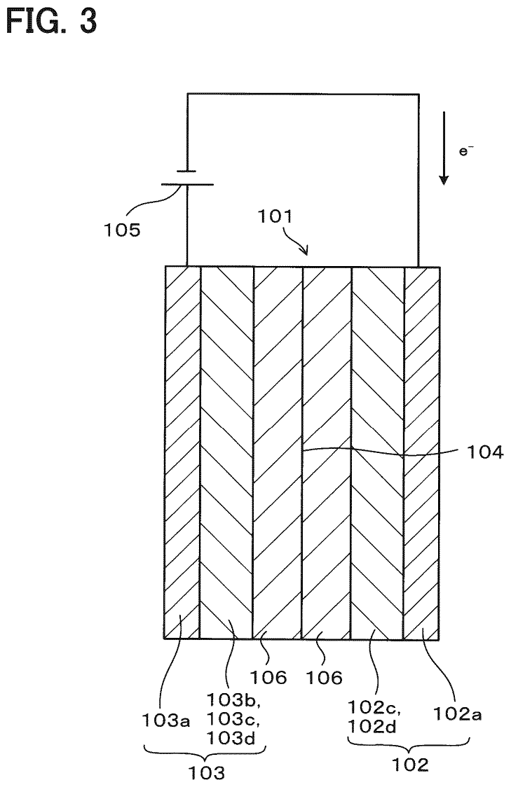

Next, the CO₂ recovery device 100 will be described with reference to FIG. 2. As shown in the FIG. 2, the CO₂ recovery device 100 includes the electrochemical cell 101 of an electric field adsorption/desorption type that adsorbs and desorbs CO₂ by electrochemical reactions. The electrochemical cell 101 includes the working electrode 102, the counter electrode 103, and the insulating layer 104. The insulating layer 104 is interposed between the working electrode 102 and the counter electrode 103. In the example shown in FIG. 2, the working electrode 102, the counter electrode 103 and the insulating layer 104 are each formed in a plate shape. Although not shown in FIG. 2, an electrolyte layer 106 is disposed between the working electrode 102 and the counter electrode 103 as shown in FIG. 3. The insulating layer 104 is disposed in the electrolyte layer 106.

The electrochemical cell 101 may be housed in a container (not shown). The container may define a gas inlet for introducing the gas to be treated into the container and a gas outlet for discharging the CO₂ removed gas and CO₂ out of the container.

The CO₂ recovery device 100 is configured to adsorb and desorb CO₂ via electrochemical reactions of the electrochemical cell 101, thereby separating and recovering CO₂ from the gas to be treated. The CO₂ recovery device 100 includes a power source 105 that applies a predetermined voltage to the working electrode 102 and the counter electrode 103, and can change a potential difference between the working electrode 102 and the counter electrode 103. The working electrode 102 is a negative electrode, and the counter electrode 103 is a positive electrode.

As shown in FIG. 4A and FIG. 4B, the electrochemical cell 101 can be operated in a switchable manner between the adsorption mode and the desorption mode by changing the potential difference between the working electrode 102 and the counter electrode 103. The adsorption mode is a mode in which CO₂ is recovered at the working electrode 102. The desorption mode is a mode in which CO₂ is emitted from the working electrode 102. The adsorption mode is a charging mode for charging the electrochemical cell 101, and the desorption mode is a discharging mode for discharging the electrochemical cell 101.

In the adsorption mode, the first voltage V1 is applied between the working electrode 102 and the counter electrode 103, and electrons are supplied to the working electrode 102. At the first voltage V1, (the working electrode potential)<(the counter electrode potential). The first voltage V1 may fall within a range from −0.1 to −5.0 V. The first voltage V1 is expressed as the working electrode potential with respect to the counter electrode potential. The same applies to the second voltage V2. However, when referring to the first voltage V1, the second voltage V2, and the like, “large” and “small” refer to the magnitude of the absolute value.

In the desorption mode, the second voltage V2 is applied between the working electrode 102 and the counter electrode 103, and electrons are supplied to the counter electrode 103. The second voltage V2 is different from the first voltage V1. When (the working electrode potential)>(the counter electrode potential), the magnitude relationship between the second voltage V2 and the first voltage V1 is not particularly limited. However, when (the working electrode potential)<(the counter electrode potential), the second voltage V2 is set to be a voltage smaller than the first voltage V1.

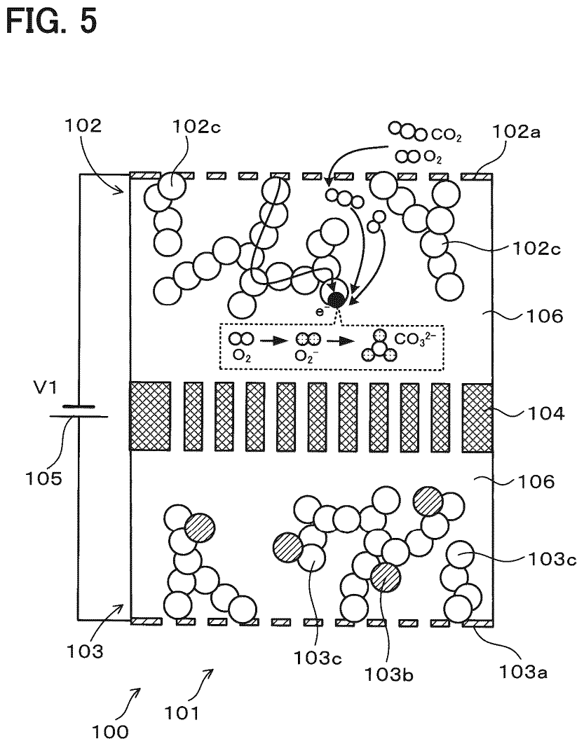

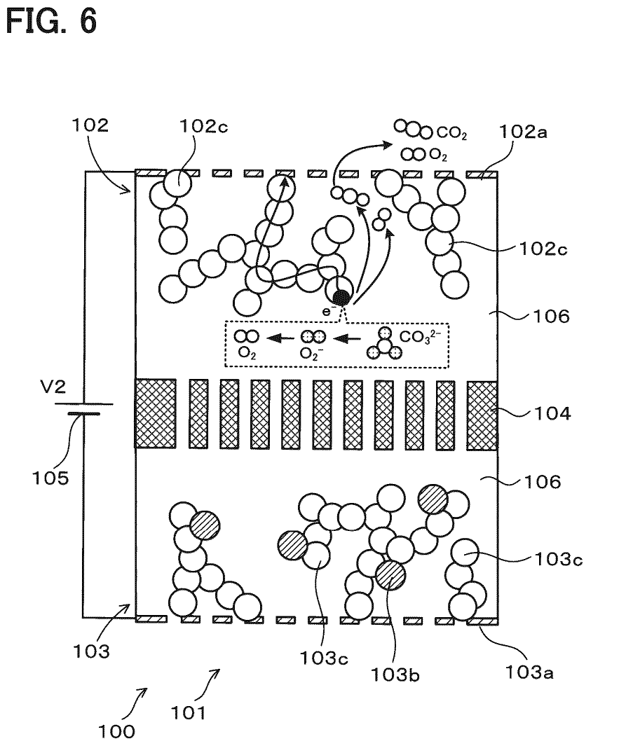

As shown in FIG. 3, the working electrode 102 includes a working electrode substrate 102a, a working electrode conductive assistant 102c and a working electrode binder 102d disposed on the working electrode substrate 102a. In FIG. 3, for convenience, the working electrode conductive assistant 102c and the working electrode binder 102d are illustrated as being arranged on one surface of the working electrode substrate 102a. However, actually, the working electrode conductive assistant 102c and the working electrode binder 102d are disposed inside the working electrode substrate 102a that is porous. FIG. 5 and FIG. 6 are schematic diagrams illustrating the configurations of the working electrode 102 and the counter electrode 103. However, also in FIG. 5 and FIG. 6, the arrangement of the working electrode conductive assistant 102c and the like is different from the actual arrangement for the sake of convenience, and the working electrode binder 102d and the like are omitted.

The working electrode substrate 102a is a porous conductive material having pores through which gas containing CO₂ can pass. As the working electrode substrate 102a, for example, a carbonaceous material or a metal material can be used. As the carbonaceous material constituting the working electrode substrate 102a, for example, carbon paper, carbon cloth, non-woven carbon mat, porous gas diffusion layer (GDL) and the like can be used. As the metal material constituting the working electrode substrate 102a, for example, a metal mesh in which a metal (for example, Al, Ni, and the like) is formed into a mesh shape can be used.

The working electrode conductive assistant 102c forms a conductive path protruding from the working electrode substrate 102a into the electrolyte layer 106. As the working electrode conductive assistant 102c, a carbon material such as carbon nanotube, carbon black and graphene can be used.

The working electrode binder 102d is provided to hold the working electrode conductive assistant 102c to the working electrode substrate 102a. The working electrode binder 102d has adhesive force and is provided between the working electrode conductive assistant 102c and the working electrode substrate 102a.

In the present embodiment, the working electrode conductive assistant 102c and the working electrode binder 102d are used in a mixed state. A mixture of the working electrode conductive assistant 102c and the working electrode binder 102d is formed, and the mixture is bonded to the working electrode substrate 102a.

As the working electrode binder 102d, a conductive resin can be used. The conductive resin may be, for example, an epoxy resin or a fluoropolymer, containing Ag or the like as a conductive filler. The fluoropolymer may be, for example, polytetrafluoroethylene (PTFE), or polyvinylidene fluoride (PVDF).

The counter electrode 103 includes a counter electrode substrate 103a, an electroactive auxiliary material 103b, a counter electrode conductive assistant 103c, and a counter electrode binder 103d disposed on the counter electrode substrate 103a. In FIG. 3, for the sake of convenience, the electroactive auxiliary material 103b, the counter electrode conductive assistant 103c, and the counter electrode binder 103d are illustrated as being arranged on one surface of the counter electrode substrate 103a. However, actually, the electroactive auxiliary material 103b, the counter electrode conductive assistant 103c, and the counter electrode binder 103d are disposed inside the counter electrode substrate 103a that is porous. The counter electrode substrate 103a, the counter electrode conductive assistant 103c, and the counter electrode binder 103d can have the same structure and material as the working electrode substrate 102a, the working electrode conductive assistant 102c, and the working electrode binder 102d in the working electrode 102, respectively.

As the electroactive auxiliary material 103b, for example, a metal complex that can transfer electrons by changing the valence of the metal ion can be used. Examples of such metal complex include cyclopentadienyl metal complexes such as ferrocene, nickelocene and cobaltocene, and porphyrin metal complexes. These metal complexes may be polymers or monomers.

Also, as the electroactive auxiliary material 103b, organic compounds such as phenothiazine, inorganic compounds such as RuO₂, MnO₂, and MoS₂, and carbon materials such as carbon black and activated carbon can be used. As the electroactive auxiliary material 103b, for example, a metal complex that can transfer electrons by changing valences of metal ions can be used. Examples of such a metal complex include cyclopentadienyl metal complexes such as ferrocene, nickelocene, and cobaltocene, porphyrin metal complexes, and the like. These metal complexes may be polymers or monomers. In the present embodiment, polyvinylferrocene is used as the electroactive auxiliary material 103b. Ferrocene transfers electrons by changing the valence of Fe between divalent an trivalent. The electroactive auxiliary material 103b is an auxiliary electroactive species that transfers electrons to and from the working electrode 102, and can also be a substance that can donate electrons by changing the valence of the elements in molecule or crystal when a potential is applied. As the electroactive auxiliary material 103b, for example, an oxide of a transition metal from Group 5 to Group 11 of the periodic table can be used. Preferably, the oxides of Cr, Mn, Fe, Co, Ni, Cu, Ru, Mo, Pd, Ag, more preferably the oxides of Cr, Mn, Fe, Ru can be used as the transition metal oxides. Furthermore, the electroactive auxiliary material 103b may have a characteristic of capturing ions (for example, electrolyte ions) in an electrolyte solution during an electrochemical reaction, and not releasing protons into the electrolyte solution during the transfer of electrons.

In the present embodiment, polyvinylferrocene is used as the electroactive auxiliary material 103b. Ferrocene transfers electrons by changing the valence of Fe between divalent an trivalent.

The insulating layer 104 is disposed between the working electrode 102 and the counter electrode 103, and separates the working electrode 102 and the counter electrode 103 from each other. The insulating layer 104 is an insulating ion permeable membrane that prevents physical contact between the working electrode 102 and the counter electrode 103 to restrict an electrical short circuit and that allows ions to permeate therethrough.

As the insulating layer 104, a separator or a gas layer such as air can be used. In the present embodiment, a porous separator is used as the insulating layer 104. As the material of the separator, a cellulose membrane, a polymer, a composite material of a polymer and a ceramic, or the like can be used.

Between the working electrode 102 and the counter electrode 103, the electrolyte layer 106 having ionic conductivity is provided. The electrolyte layer 106 is disposed between the working electrode 102 and the counter electrode 103. The electrolyte layer 106 is disposed so as to be in contact with the working electrode 102, the counter electrode 103 and the insulating layer 104.

The electrolyte layer 106 may be made of an ionic liquid, a solid electrolyte, or the like. The ionic liquid is a salt of a liquid having non-volatility under normal temperature and pressure. When the ionic liquid is used as the electrolyte layer 106, the ionic liquid may be gelled to prevent elution of the ionic liquid from the electrochemical cell 101. When the solid electrolyte is used as the electrolyte layer 106, it is preferable to use an ionomer made of a polymer electrolyte or the like.

Examples of the ionic liquid include 1-ethyl-3-methylimidazolium bis (trifluoromethanesulfonyl) imide ([EMIM][Tf₂N]), 1-butyl-3-methylimidazolium bis (trifluoromethanesulfonyl) imide ([BMIM][Tf₂N]), 1-butyl-3-methylimidazolium tetrafluoroborate ([BMIM][BF₄]), 1-ethyl-1-propylpyrrolidinium=bis (trifluoromethylsulfonyl) imide, N, bis N, N-trimethyl-N-propylammonium (trifluoromethanesulfonyl) imide, 1-ethyl-3-methylimidazolium tetrafluoroborate, 1-butyl-1-methylpyrrolidinium=bis(trifluoromethanesulfonyl) imide, and the like.

Alternatively, H₂SO₄, Na₂SO₄, KOH or the like can be used as the material of the electrolyte layer 106.

Next, the operation of the carbon dioxide recovery system 1 of the present embodiment will be described with reference to FIG. 4A, FIG. 4B, FIG. 5, and FIG. 6.

The carbon dioxide recovery system 1 operates by alternately switching between the adsorption mode shown in FIG. 4A and the desorption mode shown in FIG. 4B. The operation of the carbon dioxide recovery system 1 is controlled by the controller 14.

First, the adsorption mode will be described. In the adsorption mode, the compressor 11 operates to supply the gas to be treated to the CO₂ recovery device 100. In the CO₂ recovery device 100, the voltage applied between the working electrode 102 and the counter electrode 103 is set to the first voltage V1. Accordingly, the electroactive auxiliary material 103b of the counter electrode 103 emits electrons to be oxidized, and the electrons are supplied from the power source 105 to the working electrode 102.

As shown in FIG. 5, the electrons supplied to the working electrode 102 move through the working electrode conductive assistant 102c to a three-phase interface between the working electrode conductive assistant 102c, the electrolyte layer 106, and the gas to be treated. At the three-phase interface, oxygen contained in the gas to be treated receives electrons from the working electrode conductive assistant 102c and becomes active oxygen (O2⁻). That is, active oxygen is generated at the three-phase interface. This active oxygen combines with carbon dioxide in the gas to be treated, and the carbon dioxide is adsorbed in the vicinity of the working electrode 102. In this state, carbon dioxide (CO₂) is adsorbed in the vicinity of the working electrode 102 in a state in which carbon dioxide combines with active oxygen (O2⁻) to form CO₃²⁻.

To be precise, CO₂ is adsorbed by active oxygen in the electrolyte layer 106 in the vicinity of the working electrode 102 (more specifically, the working electrode conductive assistant 102c) . . . . However, it can also be considered that CO₂ is substantially adsorbed on the working electrode 102. Therefore, in the present specification, this state, that is, the state in which carbon dioxide is adsorbed to active oxygen in the vicinity of the working electrode 102, will also be expressed as “adsorbed to the working electrode.”

After carbon dioxide is removed from the gas to be treated in the CO₂ recovery device 100 in the adsorption mode, and the gas to be treated is discharged from the CO₂ recovery device 100 as the CO₂ removed gas. In the adsorption mode, the flow path switching valve 12 connects the gas flow path to the atmosphere, and the CO₂ removed gas discharged from the CO₂ recovery device 100 is discharged to the atmosphere (see FIG. 1).

Next, the desorption mode will be described. In the desorption mode, the compressor 11 stops operating, and the supply of the gas to be treated to the CO₂ recovery device 100 stops.

As shown in FIG. 5, in the CO₂ recovery device 100, the voltage applied between the working electrode 102 and the counter electrode 103 is set to the second voltage V2. Accordingly, the electroactive auxiliary material 103b of the counter electrode 103 receives electrons from the power source 105 to be reduced.

As shown in FIG. 6, the working electrode 102 emits electrons. Accordingly, the CO₂ that has been adsorbed to the working electrode 102 by electrostatic interaction is desorbed from the working electrode 102.

The CO₂ emitted from the working electrode 102 is discharged from the CO₂ recovery device 100. In the desorption mode, the flow path switching valve 12 connects the gas flow path to the CO₂ utilizing device 13, and the CO₂ discharged from the CO₂ recovery device 100 is supplied to the CO₂ utilizing device 13 (see FIG. 1).

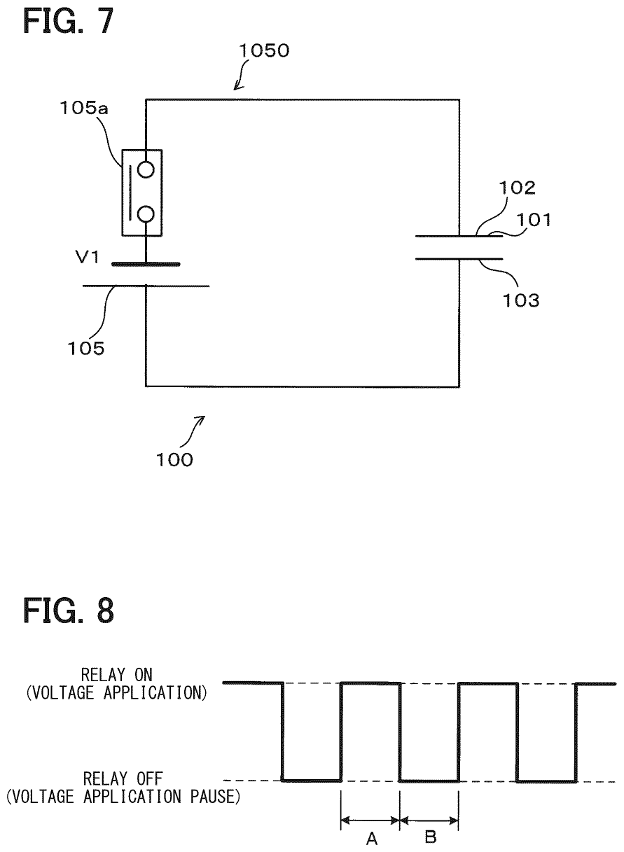

Next, the control of the voltage application to the electrochemical cell 101 in the adsorption mode will be specifically described. As shown in FIG. 7, the electrochemical cell 101 is connected to a power supply circuit 1050 that applies a voltage between the working electrode 102 and the counter electrode 103. The power supply circuit 1050 includes the power source 105 of direct current and a relay 105a connected in series to the power source 105. The controller 14 of the carbon dioxide recovery system 1 controls an on-off state of the relay 105a. The relay 105a may be, for example, a mechanical relay that utilizes electromagnetic force, or a semiconductor switch as shown in a second embodiment described later.

The pause period can be provided regardless of a disconnected state between the power source 105 and the electrochemical cell 101, for example, by making the voltage applied by the power source 105 smaller than the first voltage V1. That is, in the adsorption mode, the voltage applied by the power source 105 can be varied between the first voltage V1 and the third voltage V3 to provide a voltage application period A and a pause period B. In other words, the pause period B can be provided by temporarily setting the potential of the working electrode 102 relative to the counter electrode 103 to be higher than the first voltage V1. For example, the third voltage V3 is set so that the potential of the working electrode 102 relative to the counter electrode 103 is a value (for example, −1.0 V) higher than the first voltage V1 (for example, −1.5 V). In this manner, temporarily making the potential of the working electrode 102 with respect to the counter electrode 103 higher than the first voltage V1 also corresponds to “pausing application of the predetermined voltage” (that is, pausing application of the first voltage V1).

In the adsorption mode, the voltage applied to the electrochemical cell 101 by the power source 105 is set to the first voltage V1. In addition, in the present embodiment, the relay 105a is controlled to be turned on and off, thereby switching the power source 105 and the electrochemical cell 101 between the connected state and the disconnected state. In other words, a period during which the relay 105a is turned on is a period during which the first voltage V1 is applied to the electrochemical cell 101, and a period during which the relay 105a is turned off is a period during which application of the first voltage V1 to the electrochemical cell 101 is stopped. In this manner, as shown in FIG. 8, the pause period B during which application of the first voltage V1 to the electrochemical cell 101 is suspended is provided. In the present embodiment, a plurality of pause periods B is provided in one adsorption mode.

The first voltage V1 can be set to, for example, −0.1 to −5V. The pause period B can be set to, for example, 0.1 to 60 seconds. The voltage application period A during which the first voltage V1 is applied to the electrochemical cell 101 (that is, an interval between adjacent pause periods B) can be set to, for example, 0.1 to 60 seconds. The duration of one adsorption mode can be, for example, 10 to 7200 seconds. The duration of one desorption mode can be, for example, 10 to 7200 seconds.

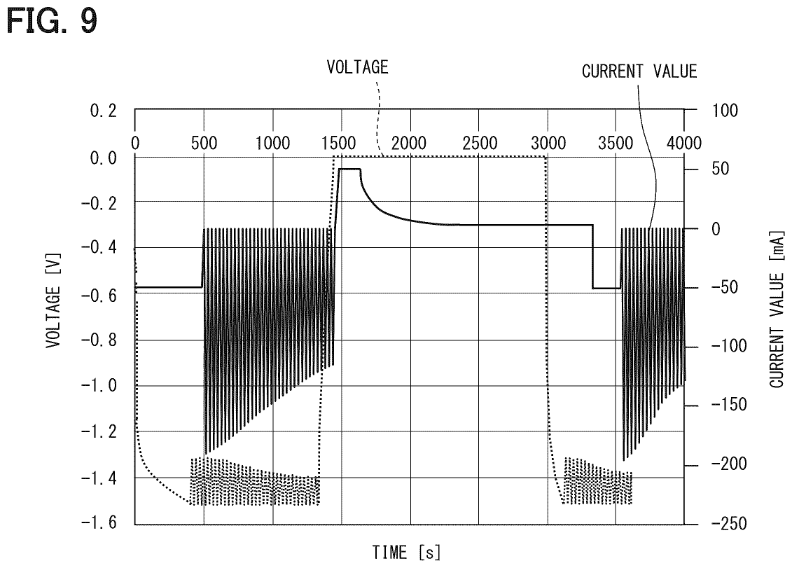

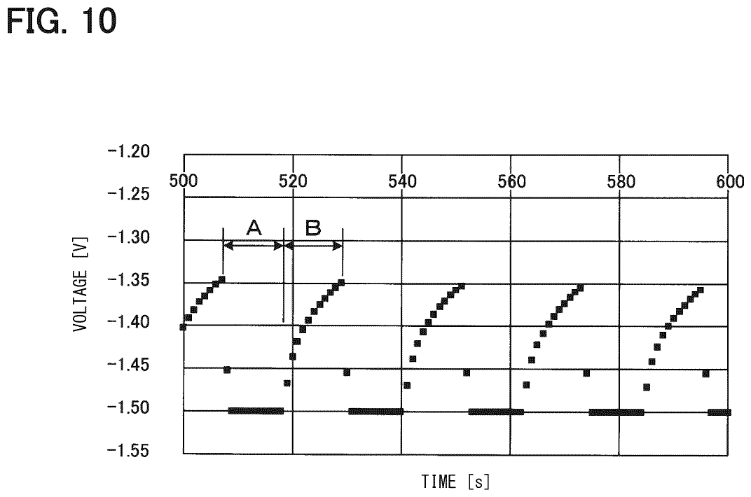

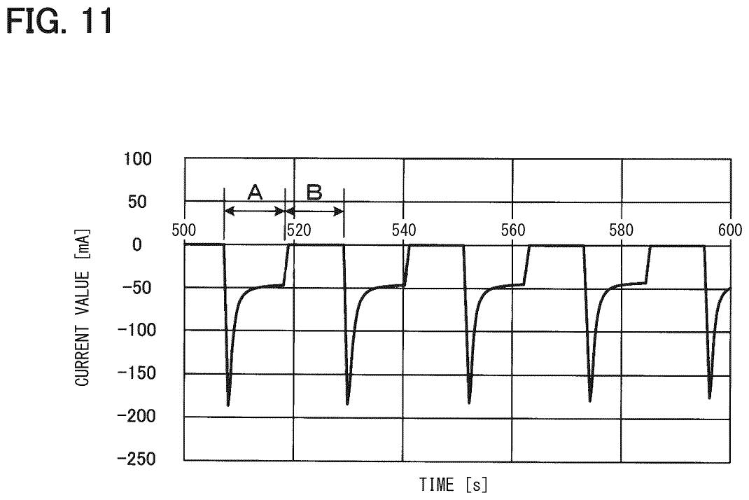

More specifically, an inter-electrode voltage in the electrochemical cell 101 (that is, the potential difference between the working electrode 102 and the counter electrode 103) fluctuates, for example, as shown in FIG. 9 and FIG. 10. In FIG. 9 and FIG. 10, the voltage is shown as the potential of the working electrode 102 with respect to the counter electrode 103, and has a negative value. In addition, in FIG. 11, the current value is expressed as a value in which the direction from the power source 105 to the working electrode 102 is regarded as positive.

During the pause period B, no voltage is applied from the power source 105 to the electrochemical cell 101, but the inter-electrode voltage of the electrochemical cell 101 fluctuates as shown in FIG. 10. In other words, when the voltage application period A is switched to the pause period B, the absolute value of the inter-electrode voltage decreases with the passage of time. On the other hand, as shown in FIG. 11, the current value in the electrochemical cell 101 becomes zero during the pause period B.

The present embodiment provides the following functions and advantages. In the carbon dioxide recovery system 1 of the present embodiment, the pause period B is provided in the adsorption mode. Accordingly, it is possible to improve at least one of the efficiency of adsorption of carbon dioxide in the adsorption mode and the efficiency of desorption of carbon dioxide in the desorption mode. As a result, the carbon dioxide recovery capacity can be improved.

The above-described effects have been confirmed by the inventors as shown in experimental examples described below. It is assumed that the above-mentioned effects are achieved by the following mechanism. In the adsorption mode, as already explained using FIG. 5 and the like, when the first voltage V1 is applied in a state where oxygen and carbon dioxide are supplied to the working electrode 102, active oxygen is generated in the vicinity of the working electrode 102 (more specifically, in the vicinity of the working electrode conductive assistant 102c), and carbon dioxide is adsorbed to the active oxygen.

When the pause period B is provided, during the pause period B, oxygen in the gas to be treated that is newly supplied to the working electrode 102 is restricted from becoming active oxygen, and new adsorption of carbon dioxide is also restricted. Therefore, during the pause period B, the concentrations of oxygen and carbon dioxide are high in the vicinity of the working electrode 102. In this manner, when the first voltage V1 is applied again in a state in which the concentrations of oxygen and carbon dioxide in the vicinity of the working electrode 102 are high, the value of the current flowing through the electrochemical cell 101 increases. That is, the Faraday efficiency increases as the CO₂ concentration in the vicinity of the working electrode 102 during adsorption increases. Here, the Faraday efficiency corresponds to the proportion of electrons supplied from the power source to the working electrode 102 that contribute to CO₂ adsorption. As a result, it is believed that the carbon dioxide adsorption efficiency is increased.

In addition, the adsorption mode has a plurality of pause periods B. Therefore, the carbon dioxide adsorption efficiency can be sufficiently improved.

As described above, according to the present embodiment, it is possible to provide a carbon dioxide recovery system capable of improving the carbon dioxide recovery capacity.

### Experimental Example

This example is an example in which the effect of improving the carbon dioxide recovery capacity by the carbon dioxide recovery system 1 of the first embodiment was confirmed. In this example, the amount of recovered carbon dioxide was measured when the adsorption mode and the desorption mode were repeated for a predetermined period of time. As shown in FIG. 9, each adsorption mode and each desorption mode were performed for 1500 seconds each. The first voltage V1 was set to −1.5 V, and the second voltage V2 was set to 0 V. In addition, in the adsorption mode, the first voltage V1 was applied intermittently. That is, a plurality of pause periods B is provided in one adsorption mode. Each pause period B was 10 seconds, and each voltage application period A was 10 seconds (see FIG. 8).

At this time, during the pause period B, the voltage of the power source 105 is not applied to the electrochemical cell 101, but the voltage between the electrodes of the electrochemical cell 101 fluctuates as shown in FIG. 10. In other words, when the voltage application period A is switched to the pause period B, the absolute value of the inter-electrode voltage decreases with the passage of time. On the other hand, as shown in FIG. 11, the current value in the electrochemical cell 101 becomes zero during the pause period B.

In a comparative example in which the pause period B was not provided and the first voltage V1 was continuously applied, the amount of recovered carbon dioxide was also measured in the adsorption mode. The comparative example is similar to the first embodiment except that the pause period B is not provided. The drive time of the first embodiment and the drive time of the comparative example were set to be the same.

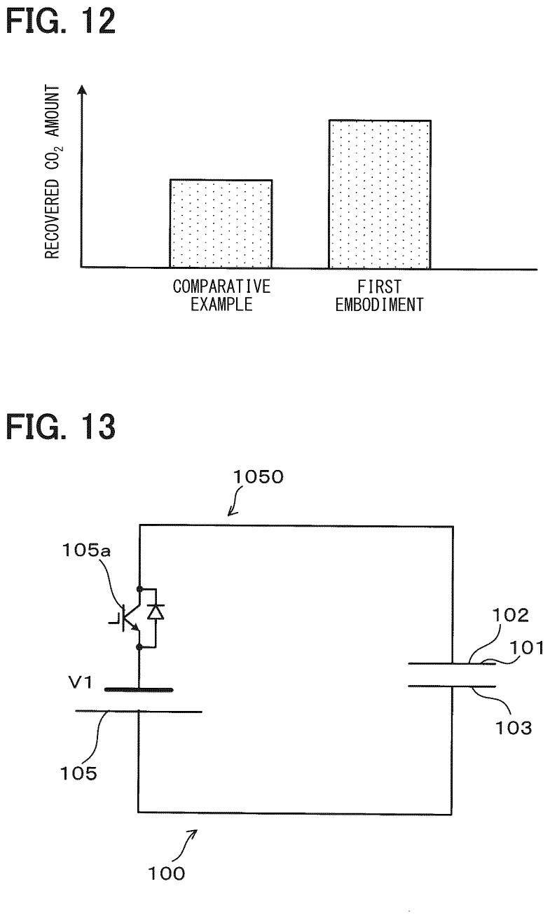

The measurement results are shown in FIG. 12. As can be seen from FIG. 12, in the first embodiment, the amount of recovered carbon dioxide is improved to about 1.7 times the amount recovered carbon dioxide in the comparative example. From the results of this example, it is considered that the carbon dioxide recovery system 1 of the first embodiment can improve the carbon dioxide recovery capacity.

### Second Embodiment

As shown in FIG. 13, a carbon dioxide recovery system 1 according to the second embodiment uses a semiconductor switch as the relay 105a in the power supply circuit. As the semiconductor switch, for example, an insulated gate bipolar transistor (IGBT) or a metal oxide semiconductor field effect transistor (MOSFET) can be used.

The rest is the same as that of the first embodiment. Those of reference numerals used in the second and subsequent embodiments which are the same reference numerals as those used in the above-described embodiments denote the same components as in the previous embodiments unless otherwise indicated.

In the present embodiment, the voltage application period A and the pause period B can be switched smoothly. Moreover, power consumption during switching can be reduced. In addition, the second embodiment has the same functions and advantages as in the first embodiment.

### Third Embodiment

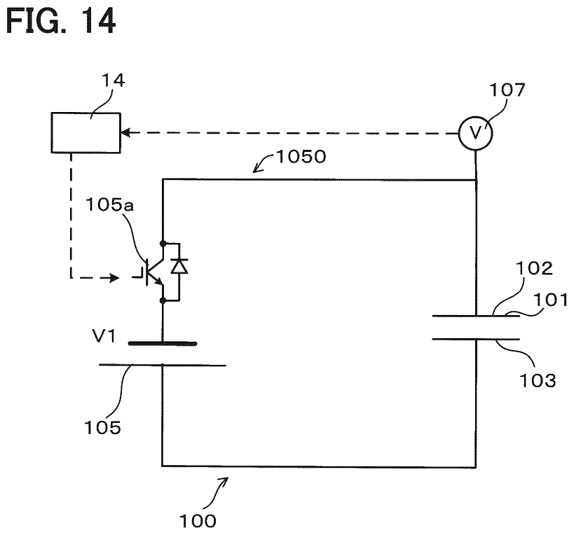

As shown in FIG. 14, s carbon dioxide recovery system 1 according to a third embodiment includes a voltage detection unit 107 that detects the voltage of the electrochemical cell 101, and is configured to end the pause period B based on the voltage detected by the voltage detection unit 107.

That is, the voltage of the electrochemical cell 101 detected by the voltage detection unit 107 (that is, the potential difference between the working electrode 102 and the counter electrode 103) is sent to the controller 14. The controller 14 ends the pause period B based on the detected voltage value. For example, as shown in FIG. 10, in the pause period B, the absolute value of the voltage of the electrochemical cell 101 gradually decreases.

When the voltage of the electrochemical cell 101 reaches a predetermined threshold value (for example, −1.35 V), the controller 14 ends the pause period B (see FIG. 10). That is, when the detected voltage value reaches the threshold value, the relay 105a is switched on. The rest is the same as that of the second embodiment.

In the case of the present embodiment, the carbon dioxide recovery capacity can be improved more effectively. That is, the absolute value of the voltage of the electrochemical cell 101 in the pause period B gradually decreases as electrons are emitted from the working electrode 102. Therefore, by detecting a decrease in the absolute value of the voltage of the electrochemical cell 101, the degree of electron emission from the working electrode 102 can be grasped. Therefore, it is possible to set the appropriate timing for ending the pause period B to be the timing when the voltage of the electrochemical cell 101 reaches the predetermined threshold value. By ending the pause period B at the timing when the voltage of the electrochemical cell 101 decreases to the predetermined threshold value, it is possible to more effectively improve the carbon dioxide recovery capacity. In addition, the third embodiment has the same functions and advantages as in the second embodiment.

Unlike the third embodiment, for example, the relay 105a may be turned on and off according to a preset control pattern. That is, a control pattern in which the start and end timings of the pause period B are preset may be stored in a memory. Based on this control pattern, the controller 14 can appropriately drive the carbon dioxide recovery system 1 by controlling the relay 105a to be on or off. Alternatively, a current detection unit that detects a current value of a current that flows through the electrochemical cell 101 may be provided, and at least one of the start and end of the pause period B may be controlled based on the current value detected by the current detection unit. For example, as shown in FIG. 11, it is conceivable that the pause period B is started when the amount of change per unit time of the current value that changes during the voltage application period A becomes small to a predetermined threshold value.

### Fourth Embodiment

In a carbon dioxide recovery system 1 according to a fourth embodiment, the pause period B is provided in the desorption mode. As in the first embodiment, in the desorption mode, the second voltage V2 is applied to the electrochemical cell 101. However, in the present embodiment, the pause period B in which the second voltage V2 is not applied is provided in the desorption mode. Also in the desorption mode, the pause period B can be provided by disconnecting the power source 105 and the electrochemical cell 101. It should be noted that the voltage application period A and the pause period B can be provided by changing the voltage applied to the electrochemical cell 101.

In the latter case, the potential of the working electrode 102 with respect to the counter electrode 103 is temporarily made lower than the second voltage V2, thereby providing the pause period B. In other words, the applied voltage during the pause period B can be set so that the potential of the working electrode 102 with respect to the counter electrode 103 is a value (for example, −0.5 V) lower than the second voltage V2 (for example, 0V). In this way, temporarily making the potential of the working electrode 102 with respect to the counter electrode 103 lower than the second voltage V2 also corresponds to “pausing application of the predetermined voltage” (that is, pausing application of the second voltage V2). The rest is the same as that of the first embodiment.

In the case of the present embodiment, the efficiency of desorption of carbon dioxide from the working electrode 102 in the desorption mode can be improved. In the desorption mode, the second voltage V2 different from the first voltage V1 is applied to the electrochemical cell 101, whereby active oxygen and carbon dioxide adsorbed on the working electrode 102 are desorbed from the working electrode 102. The desorbed oxygen and carbon dioxide accumulate in the vicinity of the working electrode 102. Thus, the concentrations of oxygen and carbon dioxide in the vicinity of the working electrode 102 increase. As a result, the efficiency of desorption of oxygen and carbon dioxide from the working electrode 102 is likely to decrease.

When the pause period B is provided, desorption of oxygen and carbon dioxide from the working electrode 102 is temporarily suspended during the pause period B. During the pause period B, oxygen and carbon dioxide in the vicinity of the working electrode 102 diffuse. As a result, the concentrations of oxygen and carbon dioxide in the vicinity of the working electrode 102 decrease. In this manner, when the second voltage V2 is applied again in a state in which the concentrations of oxygen and carbon dioxide in the vicinity of the working electrode 102 are low, desorption of oxygen and carbon dioxide from the working electrode 102 is promoted. As a result, the efficiency of desorption of carbon dioxide is increased. In addition, the fourth embodiment has the same functions and advantages as in the first embodiment.

The pause period B may be provided in both the adsorption mode and the desorption mode, or may be provided only in the adsorption mode, or may be provided only in the desorption mode.

### Fifth Embodiment

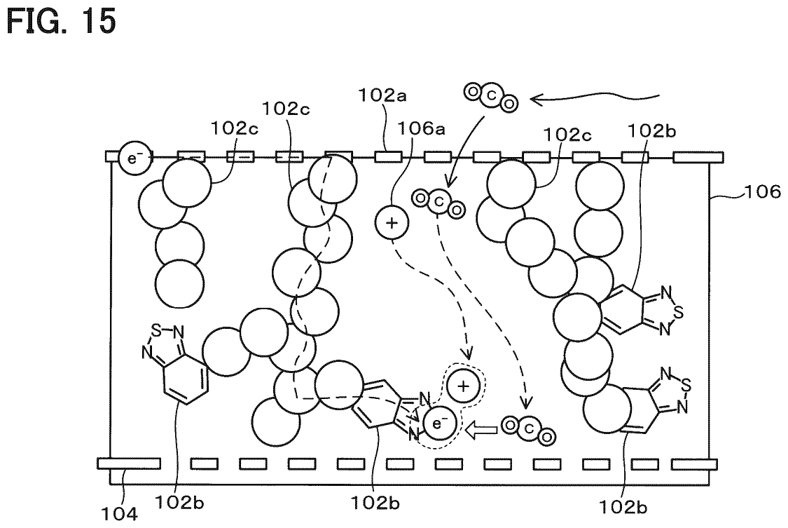

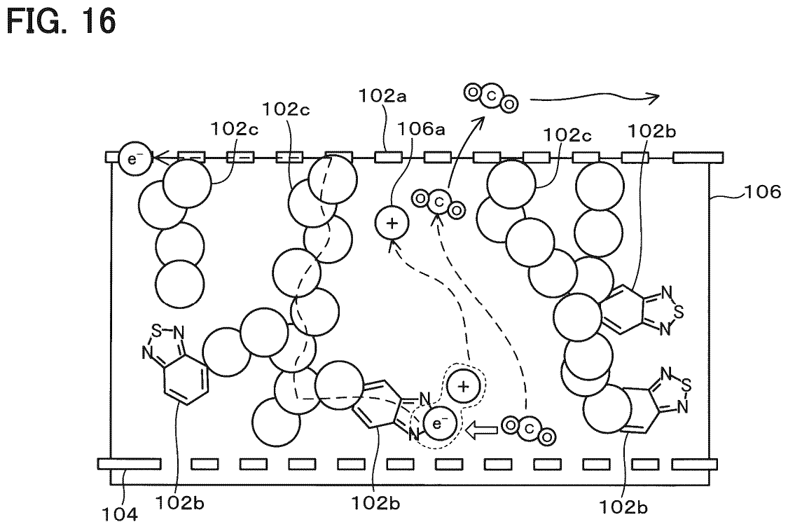

In a carbon dioxide recovery system 1 according to a fifth embodiment, as shown in FIG. 15 and FIG. 16, the working electrode 102 includes a CO₂ adsorbent 102b. In the present embodiment, the working electrode 102 includes the working electrode substrate 102a, the working electrode conductive assistant 102c, the working electrode binder 102d, and the CO₂ adsorbent 102b. The CO₂ adsorbent 102b adsorbs CO₂ by receiving electrons, and desorbs the adsorbed CO₂ by releasing electrons.

The electrolyte layer 106 is in contact with the CO₂ adsorbent 102b. Ions contained in the electrolyte layer 106 promote electron attraction of the CO₂ adsorbent 102b when the CO₂ adsorbent 102b combines with CO₂. The ions contained in the electrolyte layer 106 do not directly react with a CO₂ adsorbing site of the CO₂ adsorbent 102b that adsorbs CO₂.

The CO₂ adsorbent 102b is made of a material whose chemical skeleton does not change when adsorbing CO₂. In the present embodiment, the CO₂ adsorbent 102b is a made of material that can transfer electrons without changing its chemical skeleton when a negative potential is applied to the counter electrode 103. The CO₂ adsorbent 102b is made of a material in which, when receiving electrons from the counter electrode 103, the electric charge is delocalized in the entire material without concentrating on a specific element in its chemical structure.

When the first voltage V1 is applied between the working electrode 102 and the counter electrode 103, as shown in FIG. 15, electrons are supplied to the working electrode 102, and the CO₂ adsorbent 102b captures the electrons and adsorbs CO₂ by the Coulomb force of the electrons. When the second voltage V2 is applied between the working electrode 102 and the counter electrode 103, as shown in FIG. 16, the CO₂ adsorbent 102b emits electrons and desorbs CO₂.

As shown in FIG. 15, when the CO₂ adsorbent 102b adsorbs CO₂, the electrons absorbed in the CO₂ adsorbent 102b and the ions contained in the electrolyte layer 106 form an electric double layer. By forming the electric double layer in adsorbing CO₂ as described above, electrons can be stably retained on the surface of the CO₂ adsorbent 102b. Therefore, it is possible to adsorb CO₂ that reaches and is diffused in the vicinity of the surface of the CO₂ adsorbent 102b by the Coulomb force of the electrons.

The CO₂ adsorbent 102b of the present embodiment has the CO₂ adsorption site that captures electrons when the first voltage V1 is applied between the working electrode 102 and the counter electrode 103 and that emits the electrons when the second voltage V2 is applied between the working electrode 102 and the counter electrode 103. Since the CO₂ adsorbent 102b has the CO₂ adsorption site capable of capturing electrons in this way, electric capacity of the electric double layer can be increased.

The CO₂ adsorbent 102b may be any material that can transfer electrons without changing the structure of its chemical skeleton. The CO₂ adsorbent 102b is a material that can receive an electric charge when a potential more negative than a natural potential is applied to the CO₂ adsorbent 102b. The CO₂ adsorbent 102b does not change its chemical skeleton when transferring electrons and the electric charge is not concentrated on a specific element of the CO₂ adsorbent 102b.

In the present embodiment, an organic compound is used as the CO₂ adsorbent 102b. As the organic compound, for example, an aromatic compound can be used. It is desirable that the aromatic compound contains at least of N and S in the aromatic ring. N and S are elements having high electronegativity. In organic compounds, these elements having high electronegativity serve as the CO₂ adsorption site.

As the organic compound, for example, at least one of benzothiadiazole, polyvinylbenzothiadiazole and polydiazaphthalimide can be used. FIG. 15 and FIG. 16 illustrate an example in which benzothiadiazole is used as the CO₂ adsorbent 102b.

Next, the operation of the carbon dioxide recovery system 1 of the present embodiment in the adsorption mode will be described with reference to FIG. 15. In the adsorption mode, the first voltage V1 is applied between the working electrode 102 and the counter electrode 103. Accordingly, electrons are supplied to the working electrode 102.

The electrons supplied to the working electrode 102 move to the CO₂ adsorbent 102b via the working electrode conductive assistant 102c. The CO₂ adsorbent 102b made of an organic compound receives electrons by being reduced. When an electron is captured to the CO₂ adsorption site of the CO₂ adsorbent 102b, an electric double layer is formed between the CO₂ adsorption site having an electron bias and a cation 106a of the electrolyte layer 106.

CO₂ is attracted to the CO₂ adsorption site of the CO₂ adsorbent 102b by electrostatic interaction. As a result, CO₂ is adsorbed to the CO₂ adsorbent 102b, and the CO₂ recovery device 100 can recover CO₂ from the gas to be treated.

In the present embodiment as well, at least one of the adsorption mode and the desorption mode has the pause period B. That is, for example, the on/off control of a relay as shown in FIG. 8 is performed in at least one of the adsorption mode and the desorption mode. This makes it possible to improve the CO₂ recovery efficiency.

When the pause period B is provided in the adsorption mode, during the pause period B, carbon dioxide in the gas to be treated that is newly supplied to the working electrode 102 is restricted from being adsorbed to the CO₂ adsorbent 102b. Therefore, during the pause period B, the concentrations of carbon dioxide is high in the vicinity of the working electrode 102. In this manner, when the first voltage V1 is applied again in a state in which the concentration of carbon dioxide in the vicinity of the working electrode 102 is high, the value of the current flowing through the electrochemical cell 101 increases. As a result, the efficiency of adsorption of carbon dioxide is increased.

Furthermore, when the pause period B is provided in the desorption mode, the desorption of carbon dioxide from the working electrode 102 is temporarily suspended during the pause period B. Thus, during the pause period B, the carbon dioxide in the vicinity of the working electrode 102 diffuses. As a result, the concentration of carbon dioxide in the vicinity of the working electrode 102 decreases. In this manner, when the second voltage V2 is applied again in a state where the concentration of carbon dioxide in the vicinity of the working electrode 102 is low, desorption of carbon dioxide from the CO₂ adsorbent 102b of the working electrode 102 is promoted. As a result, the efficiency of desorption of carbon dioxide is increased.

Other configurations and advantages are similar to those of the first embodiment. In the fifth embodiment, the organic compound is used as the CO₂ adsorbent 102b. However, an inorganic compound may also be used as the CO₂ adsorbent 102b. The inorganic compound used as the CO₂ adsorbent 102b is a material that can donate and receive electrons by changing the valence of a metal element contained therein. As the CO₂ adsorbent 102b made of an inorganic compound, for example, at least one of platinum (Pt), stainless steel (SUS), nickel (Ni), inorganic oxides, inorganic nitrides, inorganic chalcogenide-based materials, and the like can be used. As the inorganic oxide, for example, an oxide of a transition metal of Groups 5 to 11 of the periodic table can be used. Preferably, the oxides of Cr, Mn, Fe, Co, Ni, Cu, Ru, Mo, Pd, Ag, more preferably the oxides of Cr, Mn, Fe, Ru can be used as the transition metal oxides.

The present disclosure is not limited to each of the above embodiments, and can be applied to various embodiments without departing from the gist thereof.

What is claimed is:

1. A carbon dioxide recovery system comprising
an electrochemical cell including a working electrode configured to come in contact with a gas to be treated that contains carbon dioxide, a counter electrode, and an insulating layer disposed between the working electrode and the counter electrode, wherein
the electrochemical cell is configured to repeat an adsorption mode and a desorption mode,
the adsorption mode is a mode in which a first voltage is applied between the working electrode and the counter electrode to supply electrons to the working electrode and cause the working electrode to adsorb the carbon dioxide in the gas to be treated,
the desorption mode is a mode in which a second voltage different from the first voltage is applied between the working electrode and the counter electrode to emit electrons from the working electrode and desorb the carbon dioxide from the working electrode,
at least one of the adsorption mode and the desorption mode has a pause period during which application of a predetermined voltage between the working electrode and the counter electrode is temporarily suspended, and
the predetermined voltage is the first voltage in the adsorption mode, and is the second voltage in the desorption mode.

2. The carbon dioxide recovery system according to claim 1, wherein
the at least one of the adsorption mode and the desorption mode has a plurality of pause periods, and each of the plurality of pause periods is the pause period.

3. The carbon dioxide recovery system according to claim 1, wherein
the adsorption mode has the pause period.

4. The carbon dioxide recovery system according to claim 1, wherein
the desorption mode has the pause period.

5. The carbon dioxide recovery system according to claim 1, further comprising
a voltage detection unit configured to detect a voltage of the electrochemical cell, wherein
the pause period is ended based on the voltage detected by the voltage detection unit.

6. The carbon dioxide recovery system according to claim 5, wherein
the pause period is ended when the voltage of the electrochemical cell reaches a predetermined threshold value.

7. The carbon dioxide recovery system according to claim 1, wherein
the pause period is started and ended at preset timings.

8. The carbon dioxide recovery system according to claim 1, wherein
the pause period is provided by disconnecting the electrochemical cell and a power source that applies a voltage to the electrochemical cell.

9. The carbon dioxide recovery system according to claim 3, wherein
in the adsorption mode, the pause period is provided by temporarily setting a potential of the working electrode relative to the counter electrode to be higher than the first voltage.

10. The carbon dioxide recovery system according to claim 4, wherein
in the desorption mode, the pause period is provided by temporarily setting a potential of the working electrode relative to the counter electrode to be lower than the second voltage.

11. The carbon dioxide recovery system according to claim 1, further comprising
a current detection unit configured to detect a current value of a current that flows through the electrochemical cell, wherein
at least one of a start and an end of the pause period is controlled based on the current value detected by the current detection unit.

12. The carbon dioxide recovery system according to claim 11, wherein
the at least one of the adsorption mode and the desorption mode has a voltage application period before the pause period, and
the pause period is started when a change per unit time in the current value of the electrochemical cell that changes during the voltage application period decreases to a predetermined threshold value.
